(19) United States
(12) Patent Application Publication
(10) Pub. No.: US 2009/0238607 A1
(43) Pub. Date: Sep. 24, 2009

(54) Development Device and Image Forming Apparatus

(75) Inventors: Kazuma MIYAZAWA, Shojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/405,015

(22) Filed: Mar. 16, 2009

(30) Foreign Application Priority Data
Mar. 21, 2008 (JP) 2008-072920
Oct. 6, 2008 (JP) 2008-259537

(51) Int. Cl. G03G 15/10

(52) U.S. Cl. 399/238

(57) ABSTRACT

A development device includes a developer reservoir that stores liquid developer containing toner and carrier liquid, a supply port that is arranged at the developer reservoir to supply the liquid developer to the developer reservoir, a supply roller that has helical grooves and supplies the liquid developer stored in the developer reservoir and a developer carrier that is supplied with the liquid developer by the supply roller and carries the supplied liquid developer, and the supply port being arranged in the direction opposite to the direction of conveyance by the helical grooves of liquid developer stored in the developer reservoir relative to the axial center of the supply roller.

### CROSS REFERENCE TO RELATED APPLICATIONS

This application is based upon and claims the benefit of priority from prior Japanese Patent Application No. 2008-072920, filed Mar. 21, 2008 and Japanese Patent Application No. 2008-259537, filed Oct. 6, 2008, the entire contents of which are incorporated herein by reference.

### BACKGROUND

1. Technical Field

The present invention relates to a development device for developing an electrostatic latent image formed on an image carrier by means of a liquid developer containing toner and carrier liquid and an image forming apparatus for forming an image by transferring a developer image developed by the development device and fixing it.

2. Related Art

There have been proposed various wet type image forming apparatus for developing and visualizing an electrostatic latent image by means of a highly viscous liquid developer prepared by dispersing solid toner in a liquid solvent. Developers that can be used for such wet image forming apparatus are prepared by suspending a solid ingredient (toner particles) in a highly viscous and electrically insulating organic solvent (carrier liquid) typically made of silicon oil, mineral oil or edible oil. The suspended toner particles are very fine and have a particle size of about 1 μm so that wet type image forming apparatus can produce high quality images if compared with conventional dry type image forming apparatus that use toner particles having a particle size of about 7 μm.

JP-A-2002-278296 (to be referred to as Patent Document 1 hereinafter) describes an image forming apparatus designed to use a liquid developer and an application roller having helically cut grooves on the surface thereof to prevent foreign objects from entering between the application roller and a quantity of application limiting member for limiting the quantity of liquid developer to be applied to the surface of the application roller. JP-A-2006-019282 (to be referred to as Patent Document 2 hereinafter) describes an image forming apparatus designed to use a supply roller around which a wire is wound in order to supply a liquid developer efficiently to a developer carrying member.

The application roller (supply roller) described in the Patent Document 1 sucks up the liquid developer that contacts a lower part of the roller and feeds it to a development roller arranged above it. It has been found that, as the application roller on the surface of which helical grooves are formed is driven to rotate on the liquid surface of the developer, the application roller exerts conveyance force for conveying the liquid developer to consequently give rise to an uneven liquid surface as indicated by a broken line in FIG. 5. Since the liquid developer is highly viscous, there arise non-contact regions between the surface of the development roller and the liquid surface of the developer as shown FIG. 8 particularly when the application roller is driven to rotate at high speed because the liquid developer comes to show an uneven surface. Additionally, it has been found that such non-contact regions occur as the duration of rotation of the application roller increases even if the application roller is not driven at high speed. Such non-contact regions by turn produce unapplied regions on the supply roller where the liquid developer is not applied to consequently give rise to a serious defect on the part of the image that is formed and output. Even if the liquid surface shows unevenness of liquid level only to a small extent, and no unapplied regions are produced, the thickness of the layer of the liquid developer formed on the surface of the application roller becomes uneven to consequently degrade the output image. The supply roller of the Patent Document 2 is highly probably accompanied by a problem same as that of the supply roller of the Patent Document 1 because a wire is wound around it so that helical grooves are formed on the surface of the supply roller.

### SUMMARY

In view of the above-identified problem, it is therefore an object of the present invention to provide a development device and an image forming apparatus that can dissolve the problem of uneven liquid surface of the liquid developer on a lower part of the surface of the supply roller where helical grooves are formed so as to make the supply roller free from unapplied regions of liquid developer and an uneven thickness of the layer of liquid developer formed on the surface thereof in order to secure a good image quality.

According to the present invention, the above object is achieved by providing a development device including: a developer reservoir that stores a liquid developer containing toner and carrier liquid; a supply port that is arranged at the developer reservoir to supply the liquid developer to the developer reservoir; a supply roller that has helical grooves and supplies the liquid developer stored in the developer reservoir; and a developer carrier that is supplied with the liquid developer by the supply roller and carries the supplied liquid developer, and the supply port being arranged in a direction opposite to a direction of conveyance by the helical grooves of liquid developer stored in the developer reservoir relative to an axial center of the supply roller.

In a development device as defined above, the supply port may be arranged vertically below the supply roller.

Preferably, in a development device as defined above, the supply port is arranged such that the liquid developer is supplied in a direction perpendicular relative to an axial direction of the supply roller.

Preferably, in a development device as defined above, the supply port is arranged such that the liquid developer is supplied in a direction opposite to a direction of conveyance by the helical grooves of liquid developer.

Preferably, a development device as defined above further includes: a collected liquid reservoir that stores a collected liquid developer; a wall section that is arranged between the developer reservoir and the collected liquid reservoir; and a collection port that is arranged at the wall section to make the liquid developer flow from the developer reservoir to the collected liquid reservoir.

Preferably, in a development device as defined above, the collection port is formed by notching part of the wall section to regulate a liquid level of the liquid developer stored in the developer reservoir.

Preferably, in a development device as defined above, the collection port is arranged at or near an axial end of the supply roller.

Preferably, in a development device as defined above, the collection port is formed by a first collection port arranged in a direction of conveyance by the helical grooves of the supply roller of liquid developer and a second collection port arranged in a direction opposite to a direction of conveyance by the helical grooves of the supply roller of liquid developer at a position vertically higher than the first collection port.

Preferably, in a development device as defined above, the supply port is arranged at a position different from a position of the collection port relative to an axial direction of the supply roller.

Preferably, in a development device as defined above, the collected liquid reservoir is provided with a discharge port that discharges the liquid developer from the collected liquid reservoir.

Preferably, in a development device as defined above, the discharge port is arranged at a side of the first collection port.

Preferably, in a development device as defined above, the developer reservoir is provided with a conveyance screw that conveys the liquid developer from the developer reservoir to the supply roller in an axial direction thereof.

Preferably, in a development device as defined above, a rate of conveyance of liquid developer to a first axial end side of the supply roller differs from a rate of conveyance of liquid developer to a second axial end side of the supply roller in an opposite direction.

In another aspect of the present invention, there is provided an image forming apparatus including: a liquid developer concentration control section that controls toner concentration of a liquid developer containing toner and carrier liquid; a supply section that supplies the liquid developer showing the toner concentration controlled by the liquid developer concentration control section; a developer reservoir that has a supply port connected to the supply section and stores the liquid developer; a supply roller that has helical grooves and supplies the liquid developer from the developer reservoir; a development section that has a developer carrier adapted to be supplied with the liquid developer from the supply roller and carry the liquid developer; and a latent image carrier that carries a latent image to be developed by the development section, and the supply port being arranged in a direction opposite to a direction of conveyance by the helical grooves of liquid developer stored in the developer reservoir relative to an axial center of the supply roller.

Preferably, an image forming apparatus as defined above further includes: a collected liquid reservoir that stores the collected liquid developer; a wall section that is arranged between the developer reservoir and the collected liquid reservoir; a collection port that is arranged at the wall section to make the liquid developer flow from the developer reservoir to the collected liquid reservoir; and a collected liquid conveyance section that collects the liquid developer stored in the collected liquid reservoir and conveys the collected liquid developer to the liquid developer concentration control section.

The above-described arrangement dissolves the problem of uneven liquid surface of the liquid developer on a lower part of the surface of the supply roller where helical grooves are formed so as to make the supply roller free from unapplied regions of liquid developer and an uneven thickness of the layer of liquid developer formed on the surface thereof in order to secure a good image quality.

### BRIEF DESCRIPTION OF THE DRAWINGS

This invention will be described with reference to the accompanying drawings, wherein like numbers reference like elements.

FIG. 1 is a schematic cross-sectional view of an image forming apparatus according to an embodiment of the present invention, showing principal components thereof;

FIG. 2 is a schematic cross-sectional view of a development device according to the present invention, showing principal components thereof;

FIG. 3 is a schematic perspective view of a supply roller that can be used for the purpose of the present invention;

FIGS. 4A and 4B are schematic cross-sectional views of a development device according to the present invention;

FIGS. 5A through 5C are schematic cross-sectional views of a development device according to the present invention;

FIG. 6 is a schematic perspective view of a development device according to the present invention, showing how it externally appears;

FIGS. 7A through 7C are schematic illustrations of conveyance screws that can be employed of an image forming apparatus according to another embodiment of the present invention;

FIG. 8 is a schematic illustration of the conventional art;

FIG. 9 is a schematic perspective view of a development device according to an embodiment of the present invention, showing how it externally appears;

FIG. 10 is a schematic cross-sectional view of a development device according to an embodiment of the present invention;

FIG. 11 is a schematic cross-sectional view of a development device according to another embodiment of the present invention;

FIG. 12 is a schematic external view of the supply roller according to the embodiment of the present invention;

FIG. 13 is a schematic cross-sectional view of a development device according to another embodiment of the present invention; and

FIG. 14 is a schematic cross-sectional view of a development device according to still another embodiment of the present invention.

### DESCRIPTION OF EXEMPLARY EMBODIMENTS

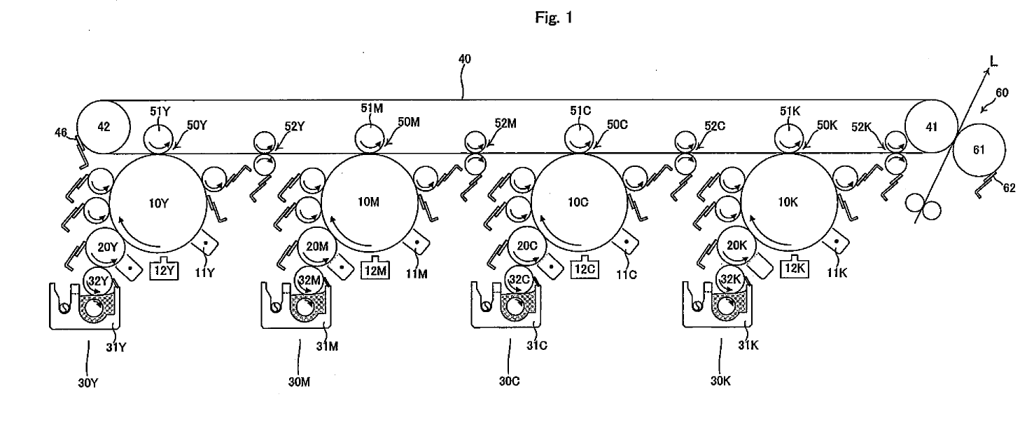

Now, preferred embodiments of the present invention will be described in greater detail by referring to the accompanying drawings. FIG. 1 is a schematic cross-sectional view of an image forming apparatus according to an embodiment of the present invention, showing principal components thereof. Image forming sections are arranged at the center of the image forming apparatus and four development devices 30Y, 30M, 30C and 30K are arranged respectively under the image forming sections while an intermediate transfer body 40 and a secondary transfer section (secondary transfer unit 60) are arranged on and above the image forming sections. In the following, only one of the image forming sections and one of the development devices 30Y, 30M, 30C and 30K will be described and the suffixes representing respective colors will be omitted because they are structurally the same.

The image forming section includes an image carrier 10, a corona charger 11 and an exposure unit 12. The exposure unit 12 has an optical system including a semiconductor laser, a polygon mirror and an F-θ lens (not shown). The image carrier 10 is uniformly electrically charged by the corona charger 11 and an electrostatic latent image is formed on the image carrier 10 by irradiating a laser beam that is modulated according to the input image signal to the electrically charged image carrier 10 from the exposure unit 12.

The development device 30 includes a developer container 31 that stores a liquid developer of the corresponding color and a supply roller 32 for applying the liquid developer to the development roller 20 from the developer container 31 and develops the electrostatic latent image formed on the image carrier 10 by means of a liquid developer of corresponding color. The intermediate transfer body 40 is typically an endless belt that is wound around a drive roller 41 and a tension roller 42 and driven to rotate by the drive roller 41, contacting the image carrier 10 at corresponding primary transfer section 50. The primary transfer section 50 includes a primary transfer roller 51 that is arranged vis-a-vis the image carrier 10 with the intermediate transfer body 40 interposed between them. The contact position of the image carrier 10 and the primary transfer roller 51 operates as a transfer position. Thus, the developed toner images of the different colors on all the image carriers 10 are sequentially transferred onto the intermediate transfer body 40 to form a full color toner image.

The secondary transfer section 60 includes a secondary transfer roller 61 that is arranged vis-a-vis the drive roller 41 with the intermediate transfer body 40 interposed between them and a cleaning device having a secondary transfer roller cleaning blade 62. The monochromatic or full color toner image formed on the intermediate transfer body 40 is transferred onto a recording medium, which may typically be a sheet of paper, film or cloth, being conveyed along a sheet member conveyance route L at the transfer position where the secondary transfer roller 61 is arranged.

A fixing unit (not shown) is arranged at a downstream position of the sheet member conveyance route L and the monochromatic or full color toner image that is transferred onto the recording medium such as a sheet of paper is fusion-bonded to the recording medium and fixed there.

The tension roller 42 bears the intermediate transfer body 40 wound around it with the belt drive roller 41 and a cleaning device having the intermediate transfer body cleaning blade 46 is held in contact with intermediate transfer body 40 at the position where the intermediate transfer body 40 is wound around the tension roller 42.

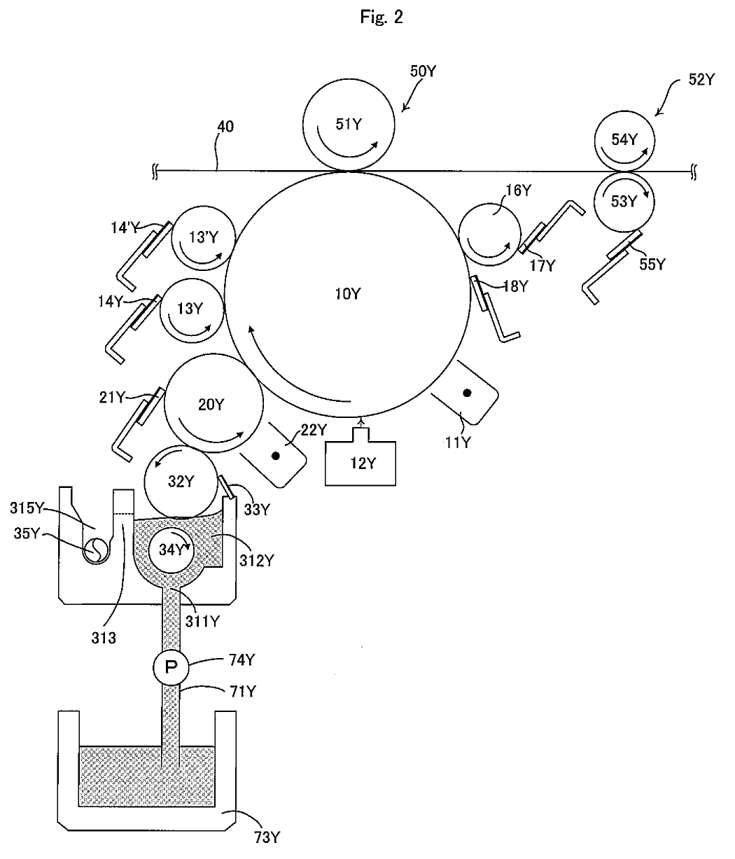

Now the image forming sections and the development devices according to the embodiment of the present invention will be described below. FIG. 2 is a schematic cross-sectional view of one of the image forming sections and one of the development devices 50, showing principal components thereof. In the following, only the yellow (Y) image forming section and the yellow development device will be described and the suffix representing the yellow color will be omitted because all the image forming sections are structurally the same and so are all the development devices.

In the image forming section, an image carrier cleaning roller 16, an image carrier cleaning blade 18, a corona charger 11, an exposure unit 12, the development roller 20 of the development device 30, an image carrier squeezing roller 13 and another image carrier squeezing roller 13′ are arranged along the outer periphery of the image carrier 10 in the mentioned order in the sense of rotation of the image carrier 10. Reference symbol 17 denotes an image carrier cleaning roller cleaning blade that cleans the image carrier cleaning roller 16. The image carrier squeezing rollers 13 and 13′ are provided respectively with cleaning devices having image carrier squeezing roller cleaning blades 14 and 14′ as auxiliary components.

A cleaning blade 21, a supply roller 32 and a toner compression corona generator 22 are arranged along the outer periphery of the development roller 20. The supply roller 32 is held in contact with a limiting blade 33 for regulating the quantity of liquid developer to be supplied to the development roller 20. The liquid developer container 31 has a developer reservoir 312 and a collected liquid reservoir 315 formed therein and a conveyance screw 34 and a collection screw 35 are respectively contained in the developer reservoir 312 and the collected liquid reservoir 315.

Primary transfer roller 51 of the primary transfer section 50 is arranged along the intermediate transfer body 40 at a position located vis-a-vis the image carrier 10 and an intermediate transfer body squeezing device 52 that includes a squeezing roller 53, a backup roller 54 and an intermediate transfer body squeezing roller cleaning blade 55 is arranged at the downstream side of the primary transfer roller 51 as viewed in the moving direction of the intermediate transfer body 40.

The image carrier 10 is a cylindrical photosensitive drum having a width larger than the development roller 20 and provided with a photosensitive layer formed on the outer peripheral surface thereof. It is typically driven to rotate clockwise as shown in FIG. 2. The photosensitive layer of the image carrier 10 is an organic image carrier, an amorphous silicon image carrier or the like. The corona charger 11 is arranged at the upstream side of the image carrier 10 relative to the nip section of the image carrier 10 and the development roller 20 and a voltage is applied to it from a power supply unit (not shown) to corona-charge the image carrier 10. The exposure unit 12 is arranged so as to irradiate a laser beam to the image carrier 10, which is electrically charged by the corona charger 11, at the downstream side relative to the corona charger 11 in the sense of rotation of the image carrier 10 to form an electrostatic latent image on the image carrier 10.

The development device 30 includes a toner compression corona generator 22 for exerting a compaction effect and a developer container 31 that stores a liquid developer in a state where toner is dispersed in carrier liquid to show a weight ratio of about 20%. The developer container 31 is provided with a collection screw 35 for collecting the liquid developer not supplied to the supply roller 32.

The developer container 31 has a supply port 311 at a lower part thereof. A developer supply route 71 is linked to the supply port 311 so that the liquid developer pumped up from the developer supply section 73 by a pump 74 is supplied to the supply port 311. The developer supply section 73 operates as a liquid developer concentration control section that controls the ratio of toner relative to carrier liquid (toner concentration). The developer supply route 71 and the pump 74 operate as supply section for supplying the liquid developer whose toner concentration is controlled to the developer reservoir 312.

Thus, the development device includes the development roller 20 for carrying the liquid developer, the supply roller 32 for applying the liquid developer to the development roller 20, the limiting blade 33 for limiting the quantity of liquid developer to be applied to the development roller 20, the conveyance screw 34 for conveying the liquid developer and supplying it to the supply roller 32, the toner compression corona generator 22 for bringing the liquid developer carried by the development roller 20 into a compacted state and the development roller cleaning blade 21 for cleaning the development roller 20.

The liquid developer contained in the developer container 31 is not a conventional popular volatile liquid developer that is a low concentration (1 to 2 wt %) and low viscosity liquid developer that is volatile at room temperature and formed by using Isopar (trademark: available from Exxon) as carrier but a high concentration and high viscosity (about 30 to 10,000 mPa·s) liquid developer showing toner solid concentration of about 20% and formed by adding a solid component prepared by dispersing a coloring agent such as a pigment into resin that is nonvolatile at room temperature into a liquid solvent such as organic solvent, silicon oil, mineral oil or edible oil with a dispersant.

The supply roller 32 has a function of supplying a liquid developer to the development roller 20. The supply roller 32 is a cylindrical member, or a roller, having projections and recesses on the surface thereof that are formed by uniformly cutting fine spiral grooves in order to make it carry the liquid developer on its surface with ease. Thus, the liquid developer is supplied from the developer container 31 to the development roller 20 by the supply roller 32. When the apparatus is in operation, the conveyance screw 34 is driven to rotate clockwise as shown in FIG. 2 to supply the liquid developer to the supply roller 32, which supply roller 32 is driven to rotate counterclockwise to apply the liquid developer to the development roller 20. Note that the conveyance screw 34 is not necessarily required to dissolve the unevenness, if any, of the level of liquid developer and hence may be omitted for the purpose of the present invention.

The limiting blade 33 is an elastic blade formed by coating an elastic member on the surface. It includes a rubber section to be held in contact with the surface of the supply roller 32, which rubber section is typically made of urethane rubber, and a metal plate for supporting the rubber section. It controls the film thickness and the quantity of the liquid developer that is carried and conveyed by the supply roller 32 so as to supply the liquid developer to the development roller 20 by a regulated quantity.

The development roller 20 is a cylindrical member that is driven to rotate counterclockwise around an axis of rotation as shown in FIG. 2. The development roller 20 is formed by arranging an elastic layer of polyurethane rubber, silicon rubber of NBR on the outer peripheral section of an inner core that is made of metal such as iron. The development roller cleaning blade 21 is typically made of rubber and adapted to be held in contact with the surface of the development roller 20. It is arranged at the downstream side relative to the development nip section where the development roller 20 contacts the image carrier 10 in the sense of rotation of the development roller 20 so as to scrape off and remove the liquid developer remaining on the development roller 20.

The toner compression corona generator 22 is an electric field application means for boosting the charged bias of the surface of the development roller 20. The liquid developer conveyed by the development roller 20 is subjected to toner compression as an electric field is applied to it at a position located close to the toner compression corona generator 22. The toner compression corona generator, or the corona discharger for discharging corona shown in FIG. 2, that operates as the electric field application means may be replaced by a compaction roller. A compaction roller is a cylindrical member having a metal roller base member and an electrically conductive resin layer or rubber layer arranged on the metal roller base member as surface layer. Such a compaction roller is driven to rotate clockwise or in the sense of rotation opposite to that of the development roller 20.

On the other hand, the liquid developer that is carried by the development roller 20 and subjected to toner compression is then subjected to a development process at the development nip section where the development roller 20 contacts the image carrier 10 so as to develop the electrostatic latent image on the image carrier 10 as a desired electric field is applied to it. The developer that is left after the development process is scraped off by the development roller cleaning blade 21 and dropped into the collection section in the developer container 31 so as to be recycled and reused.

The image carrier squeezing device is arranged at the upstream side relative to the primary transfer section and vis-a-vis the image carrier 10 at the downstream side relative to the development roller 20 to collect the surplus developer left on the image carrier 10 after the development of the toner image. It includes the image carrier squeezing rollers 13 and 13′ that are elastic roller members having an elastic surface coat and held in contact with the image carrier 10 so as to be driven to slide on the image carrier 10 and rotate and cleaning blades 14 and 14′ pressed respectively against the image carrier squeezing rollers 13 and 13′ so as to driven to slide thereon and clean their surfaces. It has a function of collecting excessive carrier liquid from the developed developer on the image carrier 10 and raising the content ratio of toner particles in the visible image. While a plurality of image carrier squeezing rollers 13 and 13′ are provided in the image carrier squeezing device so as to operate prior to the primary transfer operation in this embodiment, they may be replaced by a single image carrier squeezing roller. Still alternatively, one of the image carrier squeezing rollers 13 and 13′ may be removably held in contact with the image carrier 10 depending on the conditions of the liquid developer on the image carrier 10.

The developer image developed on the image carrier 10 is transferred onto the intermediate transfer body 40 by means of the primary transfer roller 51 in the primary transfer section 50. The image carrier 10 and the intermediate transfer body 40 are driven to move at the same speed to alleviate the load of driving them to rotate and move and suppress the effect of disturbances on the visible toner image on the image carrier 10.

The image carrier cleaning device arranged at the downstream side of the primary transfer section cleans the image carrier 10 and removes the liquid developer left on the image carrier 10 after the primary transfer operation as it is arranged vis-a-vis the image carrier at a position downstream relative to the primary transfer section 50. A bias voltage is applied to the image carrier cleaning roller 16 in order to attract toner particles in the liquid developer on the image carrier 10. Thus, the liquid developer collected by the image carrier cleaning roller 16 contains toner particles to a large extent. Thus, the solid-rich liquid developer collected by the image carrier cleaning roller 16 in this way is then scraped off by the image carrier cleaning roller cleaning blade 17 that is held in contact with the image carrier cleaning roller 16 and dropped vertically downward.

The intermediate transfer body squeezing device 52 includes the intermediate transfer body squeezing roller 53 that is an elastic roller member having an elastic surface coat and held in contact with the intermediate transfer body 40 so as to slide on the intermediate transfer body 40, the backup roller 54 arranged vis-a-vis the intermediate transfer body squeezing roller 53 with the intermediate transfer body 40 interposed between them and the intermediate transfer body squeezing roller cleaning blade 55 pressed against the squeezing roller 53 so as to slide and clean the surface thereof. It has a function of collecting the surplus carrier liquid from the developer transferred onto the intermediate transfer body 40 for primary transfer.

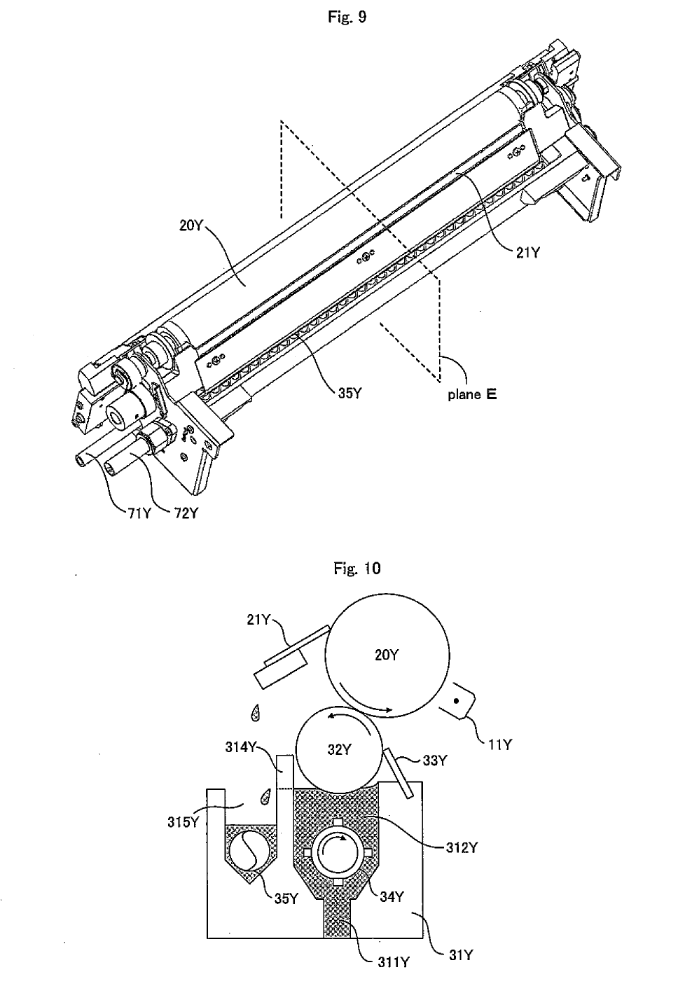

Now, a supply roller 32 that is employed for a development device and an image forming apparatus according to the present invention will be described below. FIG. 3 is a schematic perspective view of a supply roller that can be used for the purpose of the present invention and an enlarged partial view thereof. The supply roller 32 to be used for the purpose of the present invention has helical grooves 321 as indicated by oblique lines in FIG. 3 that are formed on the surface thereof for the purpose of efficiently supplying a liquid developer. As described above by referring to FIG. 2, as the supply roller 32 is driven to rotate, it sucks up the liquid developer that contacts a lower part thereof and feeds it to the developer carrier 20. When the supply roller 32 is provided with the helical grooves 321 formed on its surface as shown in FIG. 3, conveyance force is generated on the surface of the stored liquid developer by the helical grooves 321 to convey the liquid developer in the direction indicated by a leftward arrow in FIG. 8. While the conveyance force depends on the rotational speed of the supply roller 32 and the viscosity of the liquid developer, unevenness is produced to the liquid level of liquid developer in an axial direction as indicated by a broken line in FIG. 8. When the unevenness is remarkable, there may consequently arise unapplied regions where the liquid level of liquid developer does not get to the supply roller 32. Then, when such unapplied regions are formed, developer is not sufficiently supplied from the supply roller 32 to the developer carrier 20 to by turn produce defects in the formed image. Even if such unapplied regions are not formed, the supply roller 32 sucks up the liquid developer ununiformly in an axial direction when the liquid level is not even. Such a situation is by no means desirable.

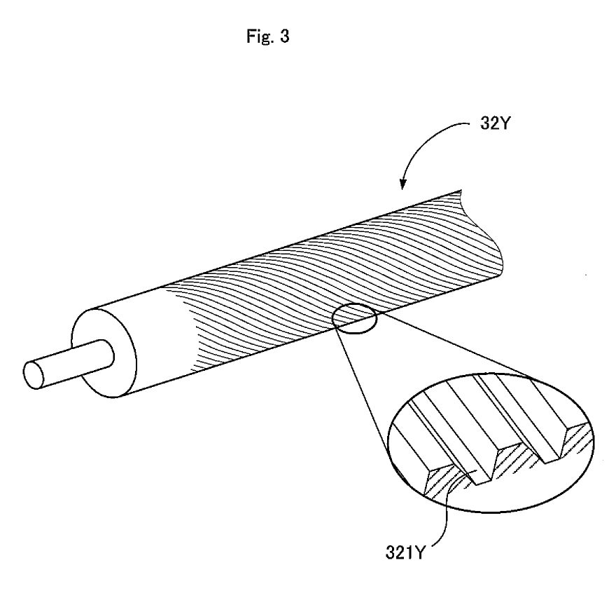

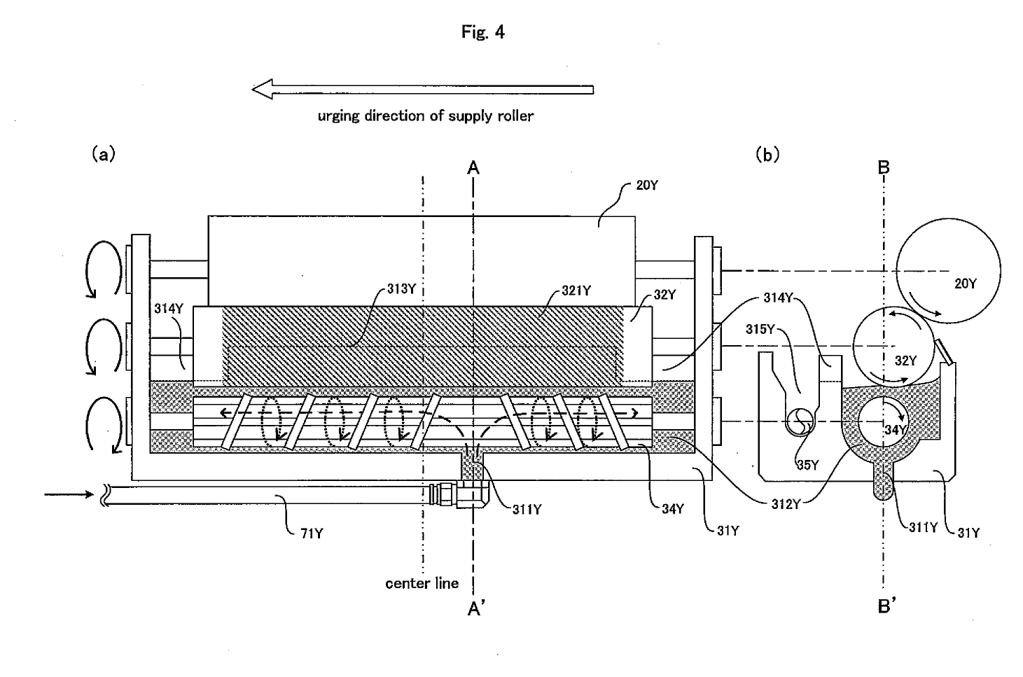

The present invention employs an arrangement as described below in order to dissolve the problem of unevenness of the liquid level caused by the liquid developer conveyed in an axial direction by revolutions of the supply roller 32. Now, principal components of a development device according to the present invention will be described below by referring to FIGS. 4A and 4B.

FIG. 4A is a cross-sectional view of a development device according to the present invention as shown in FIG. 2 taken at the supply port 311 (along line B-B′ in FIG. 4B). FIG. 4B is a cross-sectional view of the development device taken along line A-A′ in FIG. 4A.

Referring to FIG. 4A, a developer reservoir 312 is formed in the developer container 31 to store a developer. The developer container 31 is provided at a lower part thereof with a supply port 311 and the liquid developer is supplied from the supply port 311 to the developer reservoir 312. The developer container 31 is also provided with a partition section 313 that is a wall section and the partition section 313 forms the developer reservoir 312 and a collected liquid reservoir 315, which will be described hereinafter, as separate chambers.

The partition section 313 has notches near the opposite ends thereof as indicated by a broken line in FIG. 4 to reduce the height thereof at parts located near the opposite ends. The two notched parts of the partition section 313 operate as collection ports 314 for collecting the liquid developer from the developer reservoir 312 to the collected liquid reservoir 315 (the left notched part and the right notched part in FIG. 4 being referred to respectively as first collection port and second collection port).

The conveyance screw 34 is arranged in the developer reservoir 312. The conveyance fins of the conveyance screw 34 convey the liquid developer fed in from the supply port 311 toward the collection ports 314 arranged respectively at the left side and at the right side. While the conveyance screw 34 is not an indispensable component for the purpose of the present invention as pointed out earlier, it is preferably provided to efficiently circulate the liquid developer.

The supply roller 32 is arranged at a position where it contacts the liquid surface of liquid developer when the development device is driven to operate. Additionally, the supply roller 32 is arranged at a position where it contacts the developer carrier 20 so that the layer of liquid developer whose thickness is limited by the limiting member 33 can be applied to the developer carrier 20.

The liquid developer that is fed to and near the center of the developer reservoir 312 from the supply port 311 is then conveyed toward the two collection ports 314 arranged respectively at the left side and at the right side. Then, the liquid developer overflows from the collection ports 314 defined by the low heights of the corresponding parts of the partition section 313 so as to be fed into the collected liquid reservoir 315. Thus, the liquid developer stored in the developer reservoir 312 shows a uniform height in an axial direction as long as the development device is not driven to operate but the level of the liquid surface of the liquid developer changes as the supply roller 32 where the helical grooves 321 are formed according to the present invention is driven to rotate. More specifically, in the instance illustrated in FIG. 4, the liquid developer is urged lopsidedly toward the left end to raise the liquid level at the left side in an axial direction to produce an uneven liquid level when the supply roller 32 is driven to rotate.

According to the present invention, this problem of uneven liquid level is dissolved by arranging the supply port 311 at a position that characterizes the present invention. More specifically, the supply port 311 is arranged at a position lopsided to the right relative to the center line of the supply roller 32 indicated by double dot chain line in FIG. 4A that is perpendicular to an axial line thereof or in the direction opposite to the direction in which the liquid developer is urged by the supply roller 32. As the supply port 311 is arranged at such a position, the pressure of liquid developer is higher at the supply port 311 than at any other position to dissolve the problem of uneven liquid level of liquid developer.

When the collection ports 314 are formed by notching the corresponding parts of the partition section 313 and hence the collection ports 314 formed at the partition section 313 operate to regulate the liquid level of the stored liquid developer, the position of the supply port 311 is preferably other than a position below either of the collection ports 314. When the supply port 311 is arranged at a position below either of the collection ports 314, the upwardly directed pressure that is applied to the liquid developer from the supply port 311 escapes toward the corresponding collection port 314 so that the effect of the present invention that is provided by the positions of the collection ports 314 will become insufficient.

Liquid developer is supplied vertically from below from the supply port 311 into the developer reservoir 312 in the instance of FIG. 4A. However, it is not necessary that the liquid developer is supplied in such a direction and an appropriate angle of supply may be selected for supplying the liquid developer into the developer reservoir 312 in order to dissolve the problem of uneven liquid level for the purpose of the present invention. More specifically, the liquid level is raised at the left side in FIG. 4A by the revolutions of the supply roller 32 so that the liquid level can be made even by selecting an angle of supply that is inclined to the right side for supplying the liquid developer into the developer reservoir 312, or in the opposite direction relative to the raised liquid level. With such an arrangement, not only the position of arrangement of the supply port 311 but also the position at which the pressure of the liquid developer rises can be selected in a desired manner. Additionally, with such an arrangement, the degree of freedom of selection of the position of the supply port 311 in the developer container 31 is raised to provide an auxiliary advantage from the viewpoint of designing the image forming apparatus.

A color image forming apparatus includes a plurality of development devices 30 (Y, M, C and K) as shown in FIG. 1 and liquid developers of different colors are employed in the development devices 30. Then, the liquid developers employed in the respective development devices 30 (Y, M, C and K) may show respective viscosities that are different from each other. Then, the position of arrangement of the supply port 311 may be made vary among the plurality of development devices 30 (Y, M, C and K) so that liquid developers may be controlled according to their colors.

As described above, the liquid level can be held even by appropriately adjusting the position of the supply port 311 and the angle of supply of liquid developer. Therefore, differences in the viscosity of liquid developer can be flexibly accommodated when the position of the supply port 311 and the angle of supply of liquid developer from the supply port 311 into the developer reservoir 312 can be adjusted mechanically.

Additionally, the pressure of the liquid developer that is supplied from the supply port 311 is utilized for the purpose of the present invention. Therefore, the problem of uneven liquid level can be dissolved further by adjusting the pressure of the pump 74 for pumping up the liquid developer from the developer supply section 73 into the developer reservoir 312.

Furthermore, since the viscosity of liquid developer varies as a function of the temperature thereof, the pressure of the pump 74 may be adjusted according to the temperature of liquid developer. More specifically, a sensor for detecting the temperature of liquid developer may be provided and the pressure of the pump 74 may be adjusted under control by feeding back the detected temperature to maintain the liquid level even. Alternatively, a sensor for detecting the liquid level of liquid developer may be provided instead of a temperature sensor so as to adjust the pressure of the pump 74 according to the liquid level detected by the sensor. With such an arrangement, the liquid level of liquid developer can be adaptively maintained even if the viscosity of liquid developer changes as a function of the temperature thereof.

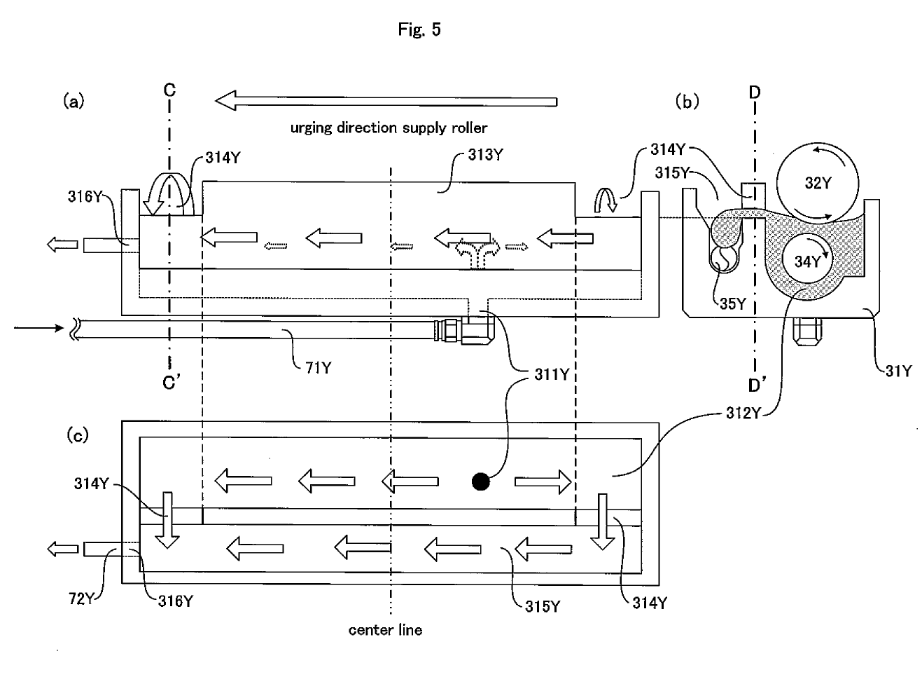

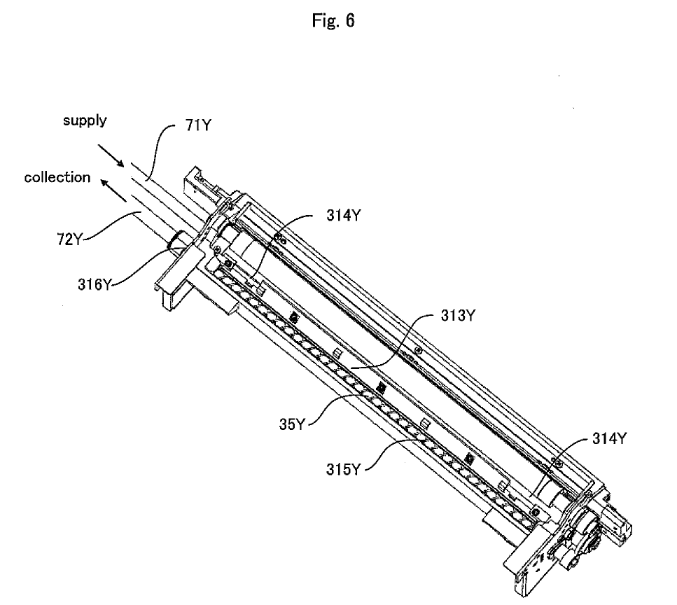

Now, collection and discharge of liquid developer for the purpose of the present invention will be described below by referring to FIGS. 5A through 5C. FIG. 5A is a cross-sectional view of the development device taken near the partition section 313 of FIG. 2 (and along line D-D′ in FIG. 5B). FIG. 5B is a cross-sectional view of the development device taken near the collection port 314 (and along line C-C′) in FIG. 5A. FIG. 5C is a top view of the development device of FIG. 5A.

As shown in FIG. 5A, the liquid developer supplied from the supply port 311 into the developer reservoir 312 is then conveyed both in the left direction and in the right direction by the conveyance screw 34 and overflows from the collection ports 314 arranged at the left and right ends to the side of the collected liquid reservoir 315. The liquid developer that overflows is conveyed in one direction by the collection screw 35 arranged in the collected liquid reservoir 315 and discharged into a developer collection route 72Y from the discharge port 316. Arrows shown in FIGS. 5A and 5C indicate the conveyance route of liquid developer. The developer collection route 72Y is connected to the developer supply section 73 that operates as a liquid developer concentration control section so that it may be referred to as a collected liquid conveyance section for reusing the collected liquid developer.

According to the present invention, the supply port 311 is arranged at a position lopsided relative to the center of an axial line of the supply roller 32 in the direction opposite to the direction in which the liquid developer is conveyed by the helical grooves 321 in order to make the liquid level even in the developer reservoir 312. However, in reality, it is not possible to make the liquid level sufficiently even in the developer reservoir 312 and it has been found that a phenomenon that a liquid developer is urged to a side by the supply roller 32 or the pressure of the liquid developer being supplied from the supply port 311 becomes dominant. Then, as a result, the quantity of overflowing liquid developer is greater at one of the two collection ports 314 than at the other collection port 314. Due to this phenomenon, the discharge port 316 is arranged at the side of the collection port 314 where the quantity of overflowing liquid developer is greater.

In the embodiment illustrated in FIGS. 5A through 5C, a liquid developer is predominantly urged in one of the opposite directions of the developer reservoir 312 by the supply roller 32 so that the discharge port 316 is arranged at the side of the collection port 314 (the first collection port) to which the liquid developer is urged by the supply roller 32 and the liquid developer is conveyed by the collection screw 35 in the direction directed to the side of the discharge port 316. With such an arrangement, the route from the collection port 314 showing a greater quantity of overflowing liquid developer to the discharge port 316 can be made short to improve the efficiency of collection of the liquid developer.

FIG. 6 is a schematic perspective view of a development device according to the present invention, showing how it externally appears. This view shows well the route by way of which the liquid developer is collected and discharged as described above by referring to FIGS. 5A through 5C. The liquid developer that is supplied from the developer supply route 71 overflows from the collection ports 314 arranged near the opposite ends of the partition section 313 and moves to the side of the collected liquid reservoir 315 where the collection screw 35 is arranged. The collection screw 35 has a helical profile as illustrated in FIG. 6 and conveys the liquid developer that overflows in a single direction toward the discharge port 316 as it is driven to rotate. The discharge port 316 is connected to the developer collection route 72 to collect the liquid developer.

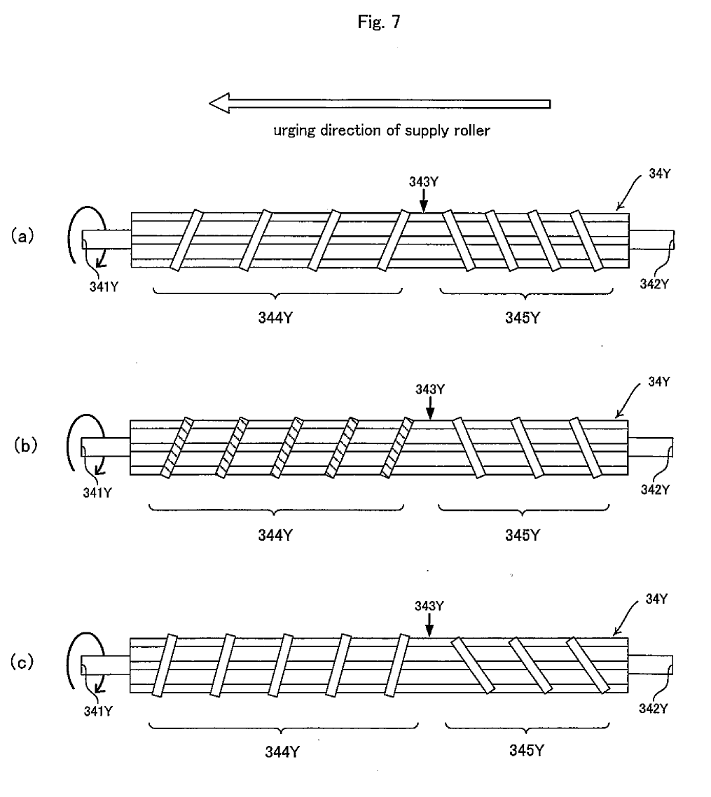

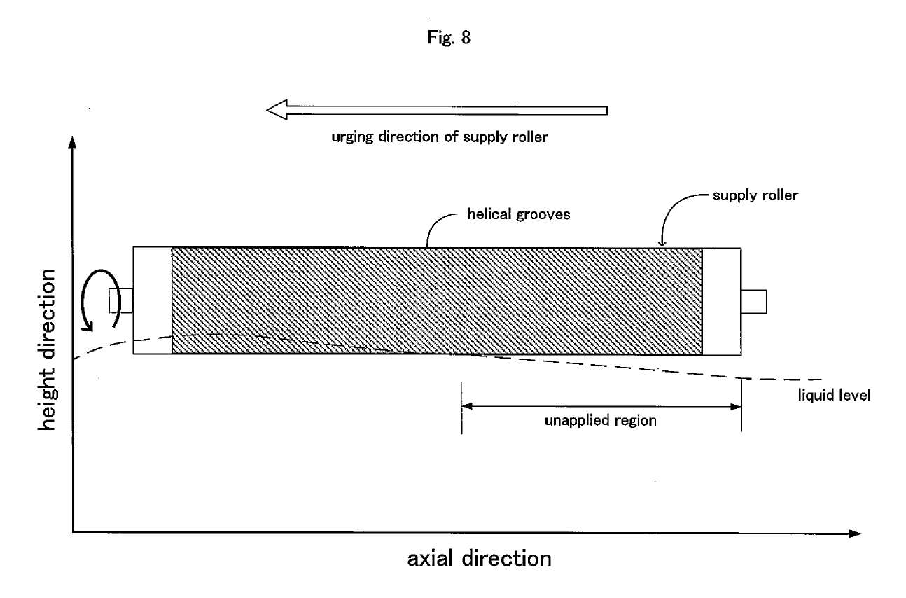

The conveyance screw 34 may be provided with a functional feature that makes the liquid level of liquid developer more even. Now, such conveyance screws 34 will be described below by referring to FIGS. 7A through 7C.

FIGS. 7A through 7C show variations of conveyance screw 34 that characterizes the present invention. As described earlier by referring to FIG. 2, the conveyance screw 34 is a member for conveying a liquid developer from the developer reservoir 312. The variations shown in FIGS. 7A through 7C are different from each other in terms of arrangement of the first conveyance fin 344 and the second conveyance fin 345. Firstly, the conveyance screw 34 of FIG. 7A will be described below particularly in terms of major components thereof.

The conveyance screw 34 shown in FIG. 7A has a shaft at the center thereof which is rotatably supported by the developer container 31 at the first shaft end section 341 and the second shaft end section 342. A plurality of conveyance fins 344 and 345 are formed on the shaft. Thus, as the conveyance screw 34 is driven to rotate, the conveyance fins 344 and 345 convey the liquid developer in an axial directions.

The two different conveyance fins including the first conveyance fin 344 and the second conveyance fin 345 are arranged so as to extend in the opposite directions from a changeover section 343 on the conveyance screw 34. The first conveyance fin 344 and the second conveyance fin 345 have respective profiles that are adapted to convey the liquid developer in opposite directions. Thus, as the conveyance screw 34 is driven to rotate in a predetermined sense of rotation, the first conveyance fin 344 is provided with conveyance force for conveying the liquid developer from the changeover section 343 toward the first shaft end section 341, whereas the second conveyance fin 345 is provided with conveyance force for conveying the liquid developer from the changeover section 343 toward the second shaft end section 342 so that the liquid developer supplied from the supply port 311 that is arranged near the changeover section 343 is conveyed in the opposite directions.

The first conveyance fin 344 and the second conveyance fin 345 shown in FIG. 7A have respective pitches of fin arrangement that are different from each other, an axial pitch of the first conveyance fin 344 being longer than an axial pitch of the second conveyance fin 345. With this arrangement, it is possible to make the rate of conveyance of liquid developer at the left side is differentiated from the rate of conveyance of liquid developer at the right side at the changeover section 343. By making an axial pitch of the first conveyance fin 344 longer than an axial pitch of the second conveyance fin 345, the rate at which the liquid developer is conveyed by the second conveyance fin 345 is greater than the rate at which the liquid developer is conveyed by the first conveyance fin 344.

In this embodiment, the unevenness of the liquid level of liquid developer that is caused by the helical grooves 321 of the supply roller 32 can be dissolved further by making use of the difference of rate of conveyance of liquid developer between the first conveyance fin 344 and the second conveyance fin 345 of the conveyance screw 34. The conveyance screw 34 having the first conveyance fin 344 and the second conveyance fin 345 that are described above is arranged in a manner as illustrated in FIG. 7A relative to the direction in which the liquid developer is urged by the supply roller 32, or the direction in which the liquid level of liquid developer is gradually raised, as indicated by a leftward arrow in FIG. 7A. As the conveyance screw 34 is arranged in this way, the urge given to the liquid developer by the supply roller 32 can be offset by the difference of rate of conveyance of liquid developer between the opposite axial directions of the conveyance screw 34 so as to make the liquid level of liquid developer more even.

Additionally, since the unevenness of the liquid level of liquid developer is principally dissolved by the positional arrangement of the supply port 311 for the purpose of the present invention, variations of the conveyance screw 34 are selectively used for auxiliary adjustment. In other words, the arrangement of the conveyance fins is not limited to the above-described one and, conversely, an axial pitch of the first conveyance fin 344 may be made shorter than an axial pitch of the second conveyance fin 345.

In each of the variations of the conveyance screw 34 shown in FIGS. 7B and 7C, the rate of conveyance of liquid developer of the first conveyance fin 344 is differentiated from the rate of conveyance of liquid developer of the second conveyance fin 345 at the changeover section 343. In both of the variations shown in FIGS. 7B and 7C, the rate of conveyance of liquid developer of the second conveyance fin 345 is made greater than the rate of conveyance of liquid developer of the first conveyance fin 344.

In the variation of FIG. 7B, the first conveyance fin 344 and the second conveyance fin 345 of the conveyance screw 34 are made of respective materials that are different from each other. For example, the first conveyance fin 344 may be an elastic member made of an elastic material while the second conveyance fin 345 may be a rigid member made of a rigid material. With this arrangement, a liquid developer is reliably conveyed by the second conveyance fin 345 that is a rigid member as the conveyance screw 34 is driven to rotate, whereas the first conveyance fin 344 that is an elastic member is partly elastically deformed due to the resistance of liquid developer to consequently relieve part of the liquid developer there from conveyance force so that the rate of conveyance of liquid developer of the first conveyance fin 344 may be made smaller than the rate of conveyance of liquid developer of the second conveyance fin 345. While an elastic member and a rigid member are selected in this example, the selection of members is by no means limited thereto so long as the rate of conveyance of the first conveyance fin 344 is differentiated from the rate of conveyance of the second conveyance fin 345. For example, elastic members may be selected for both of the conveyance fins so long as they show different moduli of elasticity.

FIG. 7C shows a conveyance screw 34 where the first conveyance fin 344 and the second conveyance fin 345 have respective angles of inclination that are different from each other, the angle of inclination of the first conveyance fin 344 being smaller than the angle of inclination of the second conveyance fin 345. With this arrangement, when the conveyance screw 34 is driven to rotate in the liquid developer, the resistance that the second conveyance fin 345 receives from the liquid developer is greater than the resistance that the first conveyance fin 344 receives so that the second conveyance fin 345 provides a greater rate of conveyance of liquid developer.

Again, since the unevenness of the liquid level of liquid developer is principally dissolved by the positional arrangement of the supply port 311 for the purpose of the present invention, the variations of the conveyance screw 34 shown in FIGS. 7B and 7C may be selectively used for auxiliary adjustment. In other words, the arrangement of the conveyance screw 34 is not limited to the above-described ones and, conversely, the configuration of the first conveyance fin 344 and that of the second conveyance fin 345 may be modified appropriately.

Variations of the conveyance screw 34 are described above by referring to FIGS. 7A through 7C to exploit the difference of rate of conveyance between the first conveyance fin 344 and the second conveyance fin 345. However, the present invention is by no means limited thereto and the rate of conveyance of the first conveyance fin 344 may be differentiated from the rate of conveyance of the second conveyance fin 345 by means of an appropriate combination of pitch, material and angle of inclination or by using some other arrangement. For example, the size of the first conveyance fin 344 may be differentiated from that of the second conveyance fin 345.

Since the major objective of the present invention to dissolve the uneven distribution of liquid developer that is produced by the supply roller 32 in an axial direction, there may be provided a plurality of first conveyance fins 344 or a plurality of second conveyance fins 345 that show different rates of conveyance. With such an arrangement, it is possible to finely adjust the rate of conveyance not only at the left side and at the right side of the changeover section 343 but also between the changeover section 343 and the first shaft end section 341 or between the changeover section 343 and the second shaft end section 342 so as to realize more even liquid surface.

Thus, as described above, according to the present invention, it is now possible to dissolve the problem of unevenness of the liquid developer under a lower part of the surface of the supply roller 32 where the helical grooves 321 are formed and hence unapplied regions of liquid developer and an uneven layer thickness of liquid developer are prevented from taking place to ensure a good image quality for the image forming apparatus.

Now, the configuration of a development device according to the present embodiment will be described below by referring to FIGS. 9 and 10. FIG. 9 is a schematic perspective view of development device, showing how it externally appears. FIG. 10 is a schematic cross-sectional view of the development device taken along plane E in FIG. 9. It will be seen from FIG. 9 how development roller cleaning blade 21 is held in contact with development roller 20. The development roller 20 and the development roller cleaning blade 21 are taken off from the development device of FIG. 6, which shows a perspective view of the development device, in order to illustrate the route of collection and discharge of liquid developer. On the other hand, FIG. 9 shows the entire development device and how it externally appears. The operation of fitting the development device in place and various servicing operations can be conducted with ease by realizing the development device as a removable unit.

FIG. 10 is a schematic cross-sectional view of the development device taken along plane E in FIG. 9 and shows a development roller 20, a development roller cleaning blade 21, a corona charger 11, a supply roller 32, a limiting blade 33, a developer container 31, a conveyance screw 34 and a collection screw 35 as components of the development device (or the development section of an image forming apparatus). As pointed out earlier, the conveyance screw 34 is not an indispensable component for the purpose of the present invention.

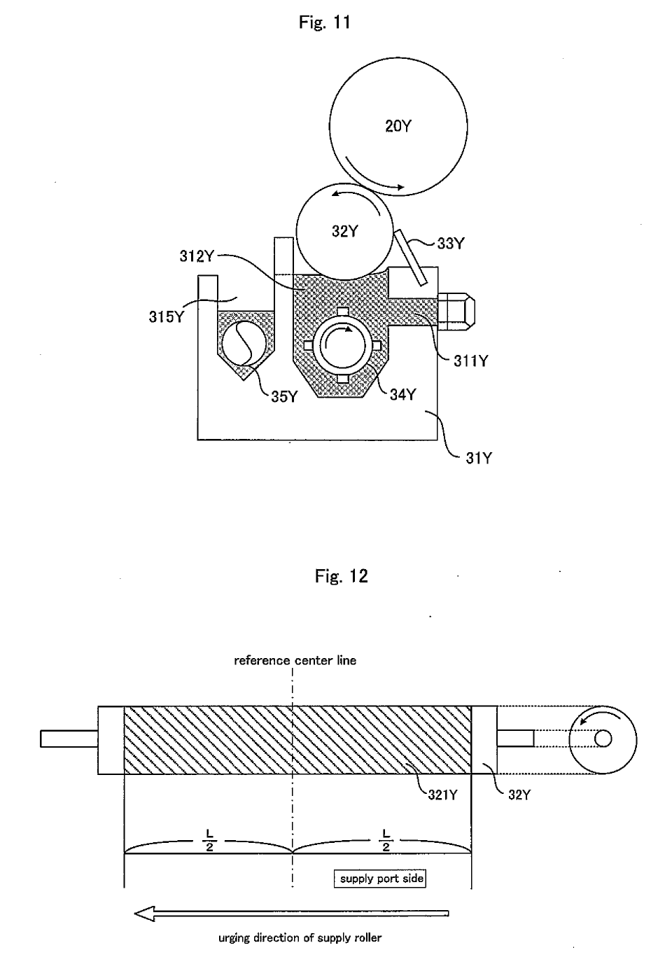

Now, the operation of supplying a liquid developer will be described below by referring to another embodiment shown in FIG. 11. In the embodiment of FIG. 4, a liquid developer is supplied vertically from below from the supply port 311 into the developer reservoir 312 and the liquid level is made even by utilizing the upwardly directed pressure being applied to the liquid developer from the supply port 311. However, it is known that the liquid level can be made even simply by arranging the supply port 311 at a position of the side opposite to that of the end of the supply roller 32 toward which the liquid developer is urged relative to an axial center of the supply roller 32 without utilizing the upwardly directed pressure. This is because a difference of flow rate of liquid developer arises and the liquid developer flows in at a higher rate at the side where the supply port 311 is arranged in a lopsided manner. Therefore, the liquid level of liquid developer can be made even without arranging the supply port 311 vertically right under the developer container 31.

FIG. 11 illustrates an embodiment where the supply port 311 is arranged not vertically right under the developer container 31. In FIG. 11, the supply port 311 is arranged at a lateral side of the developer container 31 in such a way that the liquid developer flows into the developer reservoir 312 from that lateral side. Although not shown in FIG. 11, the supply port 311 is arranged at a lopsided position of the side opposite to that of the end of the supply roller 32 toward which the liquid developer is urged relative to an axial center of the supply roller 32 as in the case of FIG. 4A. Thus, the liquid level of the liquid developer can be made even simply by arranging the supply port 311 at a lopsided position without utilizing the pressure of the liquid developer that is flowing in. With this arrangement, the position of arrangement of the supply port 311 is not limited to right under the developer container 31 and can be appropriately selected to increase the degree of freedom from the viewpoint of designing the image forming apparatus.

While the supply port 311 of the embodiment of FIG. 11 is so arranged as to supply the liquid developer from a lateral side, the angle of supply of liquid developer may alternatively be appropriately modified without changing the position of arrangement of the supply port 311. For example, if the liquid developer is made to be supplied upwardly toward the developer reservoir 312, the liquid level can be made even by utilizing the upwardly directed pressure of the entering liquid developer. If the liquid developer is made to be supplied with an angle of inclination that makes the liquid developer to enter in a direction opposite to the direction in which the liquid developer is urged by the supply roller, the supplied liquid developer is subjected to force that is directed oppositely relative to the conveyance force exerted by the helical grooves of the supply roller to be of great advantage to an even liquid level. The use of an upwardly directed angle of supply and that of an angle of supply directed in the direction opposite to the urging direction of the supply roller may be combined appropriately. Additionally, differences in the viscosity of liquid developer can be flexibly accommodated when the position of the supply port 311 and the angle of supply of liquid developer from the supply port 311 into the developer reservoir 312 can be adjusted mechanically.

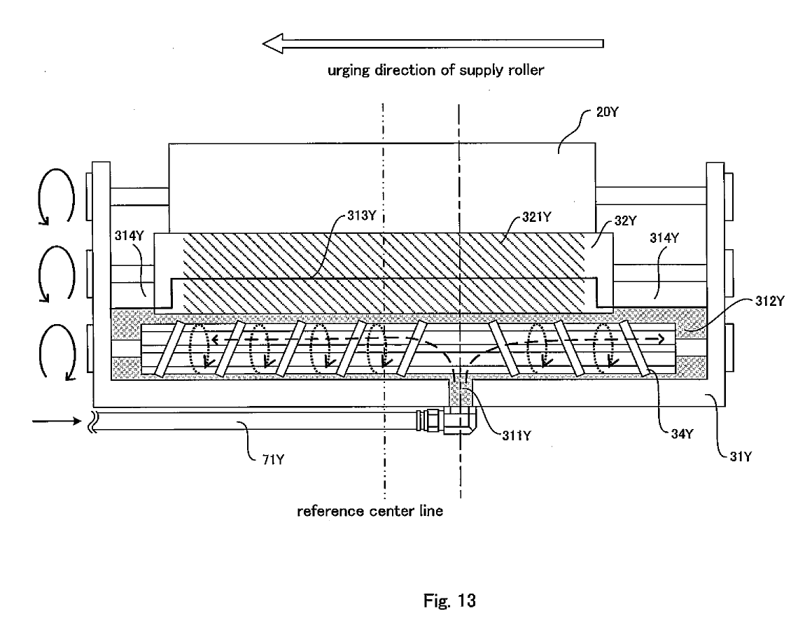

Now, other embodiments where the supply roller 32 is arranged at a different position relative to the developer container 31 will be described by referring to FIGS. 12 and 13. FIG. 12 is a schematic external view of the supply roller and FIG. 13 is a schematic cross-sectional view of another embodiment showing that the supply roller 32 and the development roller 20 are arranged in a lopsided manner relative to the developer container 31.

Firstly, the supply roller 32 will be described in greater detail in terms of an axial center thereof by referring FIG. 12. FIG. 12 is a schematic external view of the supply roller 32. The supply roller 32 is a cylindrical member and the helical grooves 321 are formed on the cylindrical surface by cutting the surface to produce such fine and uniform helical grooves so as make it capable of carrying a liquid developer with ease. The center of the region where the helical grooves 321 are formed operates as an axial center of the supply roller because the liquid developer is urged toward one of the opposite axial ends of the supply roller mainly by the helical grooves 321. More specifically, if the length of the region where the helical grooves 321 are formed is L, an axial center of the supply roller 32 is located at the position of L/2 (to be referred to as “reference center line” hereinafter). According to the present invention, the liquid level of liquid developer can be made even by arranging the supply port 311 at the side opposite to that of the end of the supply roller 32 toward which the liquid developer is urged by the supply roller 32 relative to the reference center line.

In the embodiment of FIG. 4, the center of the developer container 31 (developer reservoir 312) and the center of the supply roller 32 are substantially made to agree with each other in the longitudinal direction of the supply roller 32. On the other hand, in FIG. 13, the supply roller 32 is arranged at a position lopsided relative to the developer container 31 (developer reservoir 312) in the direction in which the liquid developer is urged by the supply roller 32. Further, the development roller 20 is also arranged at a lopsided position in accordance with the arrangement of the supply roller 32. The supply port 311 is arranged at the right side in FIG. 13 relative to the reference center line of the supply roller 32, or at the side opposite to that of the end toward which the liquid developer is urged by the supply roller 32.

With this arrangement, the developer reservoir 312 can be expanded at the right side of the supply roller 32 (at the side opposite to that of the end toward which the liquid developer is urged by the supply roller 32) so that a sufficient amount of liquid developer can be secured in the area of the developer reservoir 312 that tends to be short of the liquid developer due to the urging effect of the supply roller 32. Particularly, when a conveyance screw 34 is incorporated, the sufficient amount of liquid developer can be mixed by it to sufficiently raise the liquid level of liquid developer at the right end part of the supply roller 32 and the liquid developer can be made to reliably adhere to the supply roller 32.

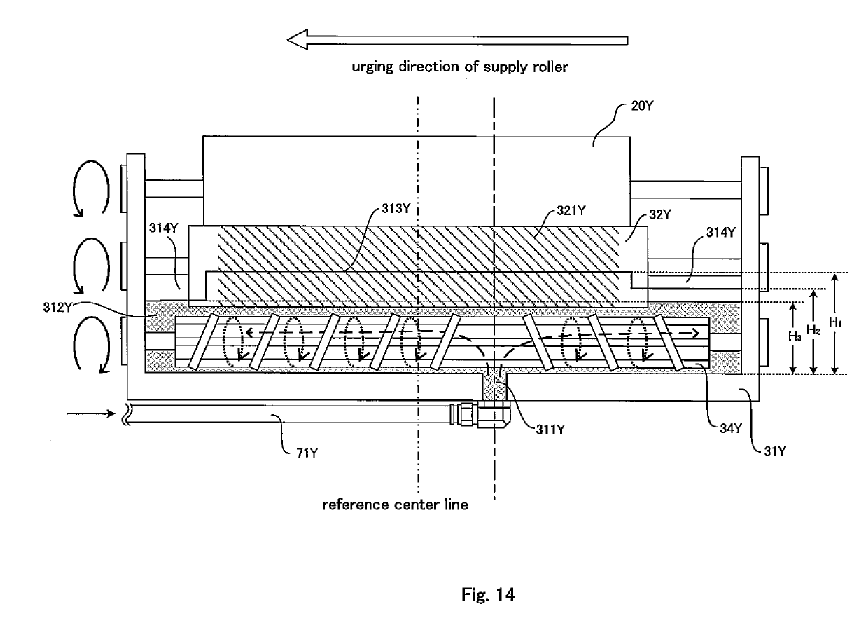

Thus, as the supply roller 32 is lopsided relative to the developer container 31 (developer reservoir 312), a sufficient amount of liquid developer can be secured at the side opposite to that of the end toward which the liquid developer is urged by the supply roller 32 in the above-described manner. Now, another embodiment designed to secure a sufficient amount of liquid developer will be described below by referring to FIG. 14. This embodiment is realized by modifying the partition section 313 of the embodiment of FIG. 13. When the collection ports 314 formed at the left and right ends of the partition section 313 is arranged at the same level in FIG. 13, the level of the collection port 314 (the second collection port at the right side in FIG. 14) located at the side opposite to that of the end toward which the liquid developer is urged by the supply roller 32 is made higher than the level of the other collection port 314 (the first collection port)+Thus, a sufficient amount of liquid developer can be secured by raising the level of the second collection port 314 so that the liquid developer can be made to reliably adhere to the supply roller 32.

This will be described more specifically below. If the height of the partition section 313 at the center thereof is H1, the level of the collection port 314 (the second collection port at the right side in FIG. 14) located at the side opposite to that of the end toward which the liquid developer is urged by the supply roller 32 is H2 and the level of the other collection port 314 (the first collection port) is H3, a relationship of H1>H2>H3 holds true. The relationship of H1>H2 is defined because, if the liquid developer adheres to the shaft of the supply roller, it can flow to the end parts of the shaft and eventually leak out.

Thus, it is possible to store a sufficient amount of liquid developer and make it reliably adhere to the supply roller 32 by expanding the developer reservoir 312 not only longitudinally but also upwardly. The levels of the collection ports 314 of FIG. 4 may be modified in a manner as shown in FIG. 14 so that the developer reservoir 312 is expanded only upwardly.

Finally, the rate of supply of liquid developer from the supply port 311 will be described below by way of specific values. If the number of helical grooves 321 formed per inch on the supply roller 32 is 150 lpi, the film thickness of liquid developer formed on the development roller 20 is 6 μm and the printing speed is 40 ppm, the rate of consumption of liquid developer per unit time is 50 cc/min. Then, the liquid level of liquid developer can be made even and a sufficient amount of liquid developer can be made to adhere to the supply roller 32 by supplying the liquid developer to an excessive supply ratio of about 150%. The excessive supply ratio [%] is defined by formula of [developer supply rate]/[developer consumption rate]×100. With this formula, the rate at which the liquid developer is supplied from the supply port 311 will be 75 cc/min. Thus, the liquid level can be held even with ease by supplying the liquid developer excessively at a rate higher than the rate at which the liquid developer is sucked up by the supply roller 32. The excessively supplied liquid developer then leaks out from the collection ports 314 so as to be collected in the collected liquid reservoir 315.

What is claimed is:

1. A development device comprising:
a developer reservoir that stores a liquid developer containing toner and carrier liquid;
a supply port that is arranged at the developer reservoir to supply the liquid developer to the developer reservoir;
a supply roller that has helical grooves and supplies the liquid developer stored in the developer reservoir; and
a developer carrier that is supplied with the liquid developer by the supply roller and carries the supplied liquid developer, and
the supply port being arranged in a direction opposite to a direction of conveyance by the helical grooves of liquid developer stored in the developer reservoir relative to an axial center of the supply roller.

2. The development device according to claim 1, wherein
the supply port is arranged vertically below the supply roller.

3. The development device according to claim 1, wherein
the supply port is arranged such that the liquid developer is supplied in a direction perpendicular relative to an axial direction of the supply roller.

4. The development device according to claim 1, wherein
the supply port is arranged such that the liquid developer is supplied in the direction opposite to the direction of conveyance by the helical grooves of liquid developer.

5. The development device according to claim 1, further comprising:
a collected liquid reservoir that stores a collected liquid developer;
a wall section that is arranged between the developer reservoir and the collected liquid reservoir; and
a collection port that is arranged at the wall section to make the liquid developer flow from the developer reservoir to the collected liquid reservoir.

6. The development device according to claim 5, wherein
the collection port is formed by notching part of the wall section to regulate a liquid level of the liquid developer stored in the developer reservoir.

7. The development device according to claim 6, wherein
the collection port is arranged at or near an axial end of the supply roller.

8. The development device according to claim 7, wherein
the collection port is formed by a first collection port arranged in the direction of conveyance by the helical grooves of the supply roller of liquid developer; and
a second collection port arranged in the direction opposite to the direction of conveyance by the helical grooves of the supply roller of liquid developer at a position vertically higher than the first collection port.

9. The development device according to claims 6, wherein
the supply port is arranged at a position different from a position of the collection port relative to an axial direction of the supply roller.

10. The development device according to claim 5, wherein
the collected liquid reservoir is provided with a discharge port that discharges the liquid developer from the collected liquid reservoir.

11. The development device according to claim 10, wherein
the discharge port is arranged at a side of the first collection port.

12. The development device according to claim 1 through 11, wherein
the developer reservoir is provided with a conveyance screw that conveys the liquid developer from the developer reservoir to the supply roller in an axial direction thereof.

13. The development device according to claim 12, wherein
a rate of conveyance of liquid developer to a first axial end side of the supply roller differs from a rate of conveyance of liquid developer to a second axial end side of the supply roller in an opposite direction.

14. An image forming apparatus comprising:
a liquid developer concentration control section that controls toner concentration of a liquid developer containing toner and carrier liquid;
a supply section that supplies the liquid developer showing the toner concentration controlled by the liquid developer concentration control section;
a developer reservoir that has a supply port connected to the supply section and stores the liquid developer;
a supply roller that has helical grooves and supplies the liquid developer from the developer reservoir;
a development section that has a developer carrier adapted to be supplied with the liquid developer from the supply roller and carry the liquid developer; and
a latent image carrier that carries a latent image to be developed by the development section, and
the supply port being arranged in a direction opposite to a direction of conveyance by the helical grooves of liquid developer stored in the developer reservoir relative to an axial center of the supply roller.

15. The image forming apparatus according to claim 14, further comprising:
a collected liquid reservoir that stores the collected liquid developer;
a wall section that is arranged between the developer reservoir and the collected liquid reservoir;
a collection port that is arranged at the wall section to make the liquid developer flow from the developer reservoir to the collected liquid reservoir; and
a collected liquid conveyance section that collects the liquid developer stored in the collected liquid reservoir and conveys the collected liquid developer to the liquid developer concentration control section.
